(19) United States
(12) Patent Application Publication
(10) Pub. No.: US 2022/0212702 A1
(43) Pub. Date: Jul. 7, 2022

(54) HAND CART HAVING LATERAL COUPLING MEANS

(71) Applicant: Jounghak CHANG, Anyang-si (KR)

(72) Inventor: Jounghak CHANG, Anyang-si (KR)

(21) Appl. No.: 17/606,423

(22) PCT Filed: Apr. 24, 2020
(86) PCT No.: PCT/KR2020/005419

§ 371 Date: Oct. 25, 2021

(30) Foreign Application Priority Data
Apr. 26, 2019 (KR) 10-2019-0048906

(51) Int. Cl. B62B 3/02; B62B 5/00

(52) U.S. Cl. CPC B62B 3/02; B62B 2205/20; B62B 5/00

(57) ABSTRACT

The present invention relates to a hand cart, for loading and transferring an article, comprising: a loading board (10) on which an article is loaded; a first coupling plate (20) and a second coupling plate (30) alternately formed on the lateral surface of the loading board; an L-shaped first coupling groove (50) formed on one edge of the upper surface of the loading board; a second coupling groove (55) formed on the other edge of the upper surface of the loading board; and a H-shaped coupling pin (60) mounted on the first coupling groove. The upper surface of the first coupling plate (20) is formed on the same level as or lower than the bottom surface of the second coupling plate. When two hand carts are coupled side by side, the upper surface of a first coupling plate (20) is mutually coupled to the bottom surface of a second coupling plate (30) by overlapping such that the carts do not shake vertically or horizontally.

### FIELD OF INVENTION

The present invention relates to a hand cart extendable using various methods by including coupling devices on a side surface thereof.

### BACKGROUND OF INVENTION

A hand cart designed for the purpose of transporting loaded goods is a transport device for putting various goods on a loading plate and moving the loading plate a corresponding direction by a transport wheel installed on a bottom surface when a transporter pulls a handle in a desired direction.

In the case of such a hand cart, goods of an appropriate weight needs to be loaded to provide safe transport and facilitate a transport operation of a transporter in transporting the loaded goods, and a loading height of goods needs to be set to a level that does not obstruct a view in the transport operation in consideration of the transporter's physique.

With regard to the prior art related to a hand cart provided to effectively and safely load goods,

Korean Patent 10-1106592 discloses a (hereinafter referred to as “prior art”).

However, in the case of existing hand carts as well as the prior art,

Irrespective of a transporter who transports goods or a type of the goods being loaded, the goods are loaded and transported within an already equipped structure, and thus there is a problem in that many restrictions and inconveniences are caused.

As a loading plate of a hand cart simples forms a single plate shape, there is a problem in that it is difficult co change the loading plate of the hand cart to various sizes depending on the size of a loadable item.

### SUMMARY OF INVENTION

### Technical Problem to be Solved

The present invention provides a device for extending a loading plate for loading goods thereon using various methods in a hand cart for transporting goods.

### Technical Solution

Therefore, the present invention provides a hand cart a loading plate 10 on which goods are loaded, a first coupling plate 20 and a second coupling plate 30 that are alternately formed on a side surface of the loading plate, a first coupling groove 50 shaped like “L” and formed at one edge of an upper surface of the loading plate, a second coupling groove 55 formed at a remaining edge of the upper surface of the loading plate, and a coupling pin 60 shaped like “C” and installed in the first coupling groove, wherein a height of an upper surface 22 of the first coupling plate 20 is equal to or lower than a height of a lower surface 32 of the second coupling plate 30.

When side surfaces of the two hand carts are coupled to each other, the upper surface 22 of the first coupling plate 20 may overlap the lower surface 32 of the second coupling plate 30.

The coupling pin 60 may include a horizontal part 62 having a predetermined width and a first vertical part 64 and a second vertical part 66 that extend downward from both ends of the horizontal part, the first vertical part 64 extending with a relatively long length, and the second vertical part 66 extending with a relatively short length.

The first coupling groove 50 may include a horizontal groove 51 formed in parallel to the side surface of the hand cart, a vertical groove 53 extending from one end of the horizontal groove 51 to be perpendicular to the side surface of the hand cart, and a first hole 54 and a second hole 52 that are formed in both ends of the horizontal groove 51 to be perpendicular to the upper surface of the hand cart, wherein a first vertical part 64 of the coupling pin is installed in the first hole 54, and the second vertical part 66 is installed in the second hole 52.

When side surfaces of the two hand carts are coupled to each other, the second coupling groove 55 corresponding to the vertical groove 53 of the one hand cart may be formed in the side surface of the remaining one of the hand carts.

A third hole 56 may be formed in the second coupling groove 55 to be perpendicular to the upper surface of the hand cart, and the second vertical part 66 of the coupling pin 60 may be installed in the third hole 56 to couple the two hand carts.

A protection plate 70 formed perpendicular to the lower surface of the hand cart while surrounding an external side of the first hole 54 may be provided on the lower surface of the hand cart, and in a state in which the first vertical part 64 of the coupling pin is installed in the first hole 54, the protection plate 70 may protect a user from the first vertical part of the coupling pin.

The hand cart may further include a string storage member 80 provided on the lower surface of the hand cart and protruding vertically at a predetermined interval from the lower surface to store a wound string connected to the hand cart to drive the hand cart.

### Effect of Invention

By virtue of the above configuration according to the present invention, side surfaces of hand carts may be successively coupled, and the hand carts may be fixedly coupled to each other not to be moved vertically and horizontally while being coupled to each other, and thus the size and shape of the hand carts may be extendable to various sizes depending on an environment of a work place, and the hand carts may be used various working environments.

### BRIEF DESCRIPTION OF DRAWINGS

FIG. 1 is a diagram showing the state in which two hand carts are coupled to each other according to the present invention,

FIG. 2 is a perspective view of a hand cart with a handle coupled thereto according to the present invention.

FIG. 3 is a perspective view of a hand cart without a handle coupled to the hand cart of FIG. 2.

FIGS. 4 and 5 are diagrams showing an upper surface of a hand cart in the state in which two hand carts are coupled when the two hand carts are coupled to each other according to the present invention, FIG. 4 showing a portion A of FIG. 2, and FIG. 5 showing a portion B of FIG. 3.

FIG. 6 is a perspective view of a coupling pin for coupling hand carts to each other according to the present invention.

FIG. 7 is a diagram showing the state in which two hand carts are coupled to each other according to the present invention.

FIG. 8 is a perspective view showing a bottom surface of a hand cart according to the present invention.

FIGS. 9 to 12 are diagrams showing the case in which hand carts are coupled in various ways according to the present invention.

### BEST MODE

Hereinafter, objects, advantageous features, and new features of various embodiments of the present invention will be described in detail with reference to the accompanying drawings. The terms used in the specification are defined in consideration of functions used in the present invention, and can be changed according to the intent or conventionally used methods of users, and operators.

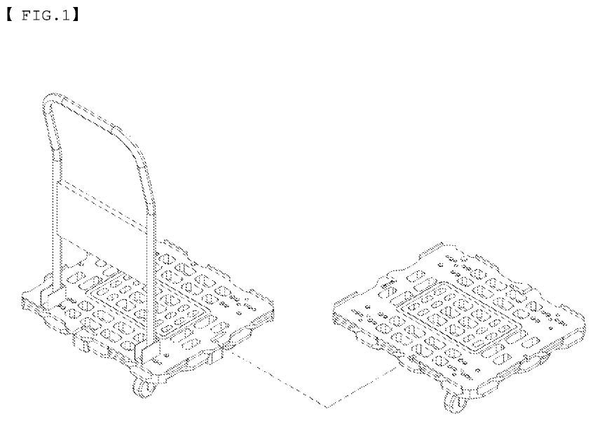

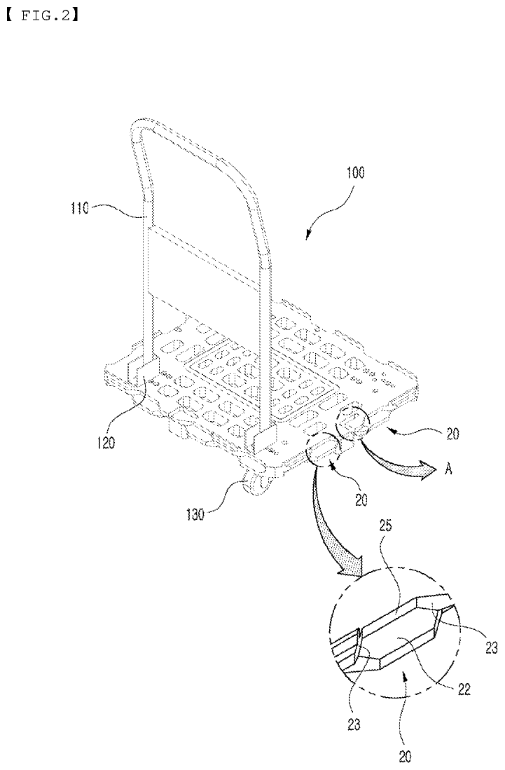

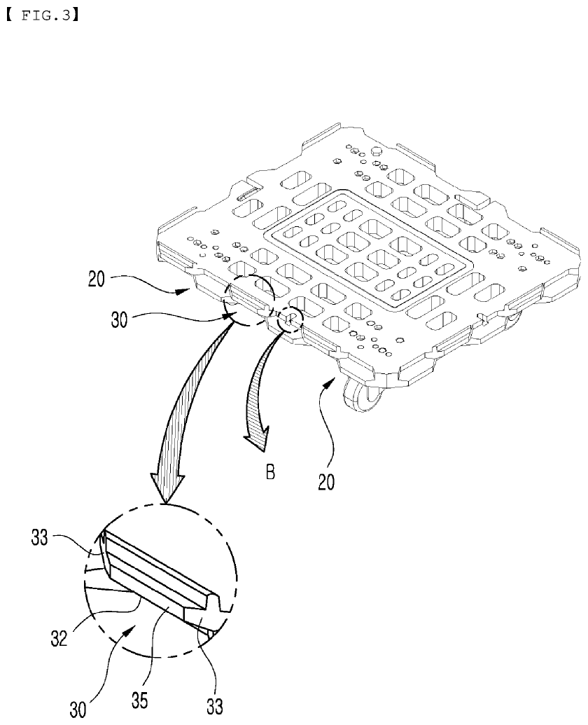

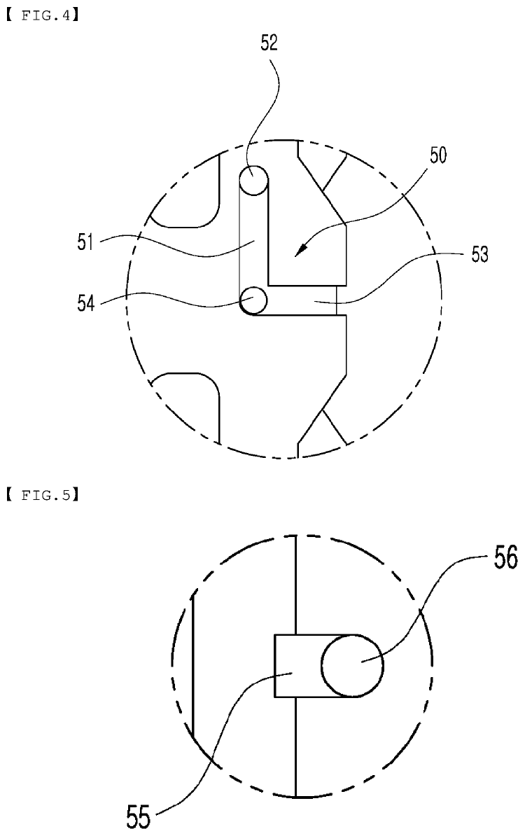

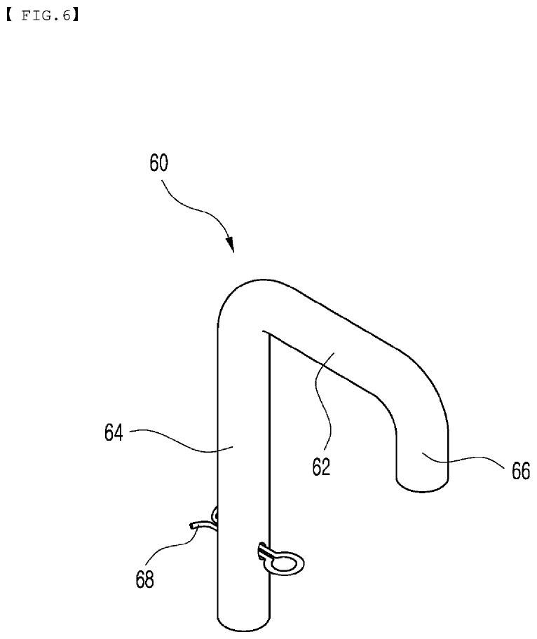

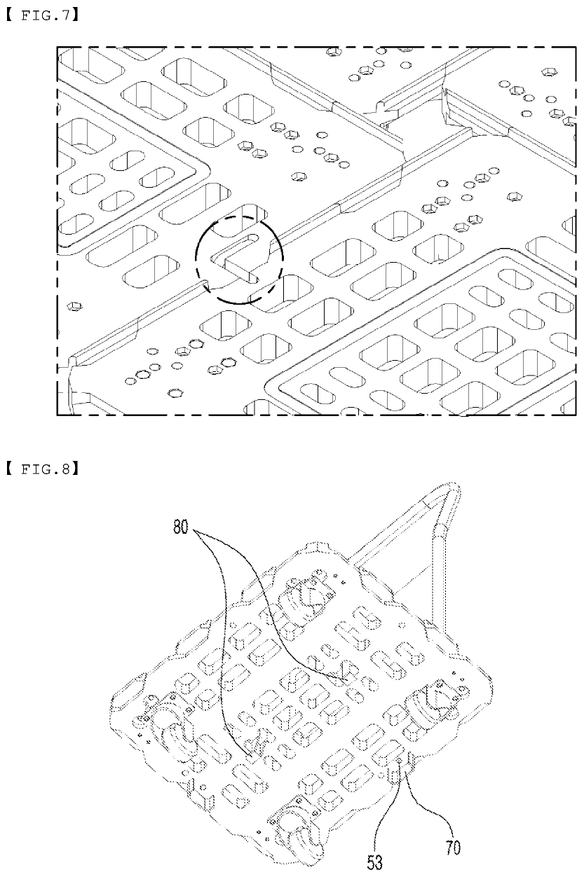

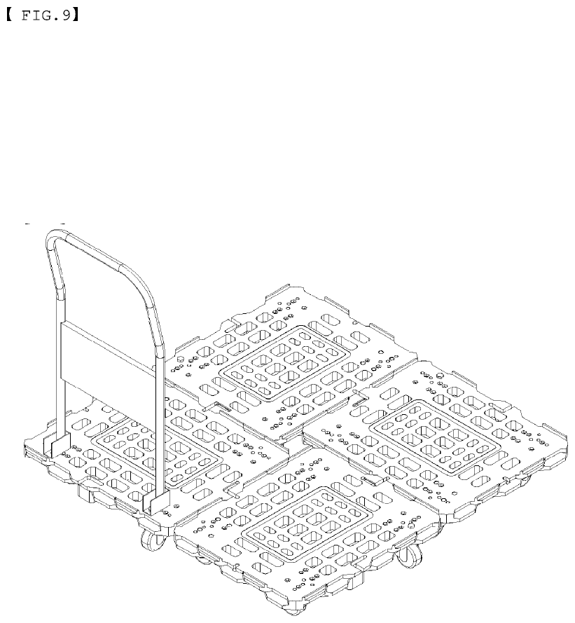

FIG. 1 is a diagram showing the state in which two hand carts are coupled to each other according to the present invention. FIG. 2 is a perspective view of a hand cart with a handle coupled thereto according to the present invention. FIG. 3 is a perspective view of a hand cart without a handle coupled to the hand cart of FIG. 2. FIGS. 4 and 5 are diagrams showing an upper surface of a hand cart in the state in which two hand carts are coupled when the two hand carts are coupled to each other according to the present invention. FIG. 6 is a perspective view of a coupling pin for coupling hand carts to each other according to the present invention. FIG. 7 is a diagram showing the state in which two hand carts are coupled to each other according to the present invention. FIG. 8 is a perspective view showing a bottom surface of a hand cart according to the present invention. FIGS. 9 to 12 are diagrams showing the case in which hand carts are coupled in various ways according to the present invention.

The present invention relates to a hand cart that is expandable by combining adjacent hand carts in various ways by including coupling devices on a side surface thereof.

A hand cart 100 according to the present invention may include a loading plate 10 on which goods are loaded, a handle 110 held by a person for transport, a plate 120 for fixing the handle to the loading plate 10, and a wheel 130 provided at a lower part of the hand cart 100. The handle may be fixed to an upper surface of the loading plate using the plate, and the plate 120 may be fixed to an upper part of the loading plate using a bolt. The handle may also be fixed to different positions by moving being moved on the loading plate rather than being fixed to a specific position.

The hand cart according to the present invention may include the loading plate 10 on which goods are loaded, and in this case, the hand cart may each transport goods, but according to the present invention, the hand carts may also be coupled to each other at side surfaces thereof.

To couple side surfaces of loading plates to each other, a first coupling plate 20 and a second coupling plate may be alternately formed on a side surface of the loading plate according to the present invention. The first coupling plate 20 may be formed at a relatively low position, and the second coupling plate 30 may be formed at a relatively high position, and thus when side surfaces of the two hand carts are coupled to each other, an upper surface 22 of the first coupling plate 20 may be formed to overlap a lower surface 32 of the second coupling plate 30. In detail, the upper surface 22 of the first coupling plate 20 and the lower surface 32 of the second coupling plate 30 may be formed at the same height.

The first coupling plate 20 may have a hexagonal shape viewed from above (however, other shapes may be possible). On opposite sides of the first coupling plate 20, a guide inclined surface 23 inclined toward the center of the loading plate may be formed as a vertical surface, and a vertical contact surface 25 may be formed between the two guide inclined surfaces on opposite sides.

According to the present invention, a plurality of hand carts may be coupled to each other side surfaces thereof, and for convenience of description, one of the coupled hand carts is referred to as a first cart, and the other hand cart is referred to as a second cart. With regard to a method of coupling hand carts, the first coupling plate 20 of the first cart and the second coupling plate 30 of the second cart may be coupled while overlapping up and down. The lower surface of the second coupling plate may be positioned on the upper surface of the first coupling plate 20, and the second coupling plate 30 may include protruding couplers 33 and 35 that protrudes to the outside and have shapes corresponding to the guide inclined surface 23 and the vertical contact surface 25 of the first coupling plate 20. The hand carts may be coupled to each other while an inclined part 33 of the protruding couplers 33 and 35 is guided by the guide inclined surface 23, and a front end 35 of the protruding couplers 33 and 35 is in contact with the vertical contact surface 25.

As such, when the two hand carts are coupled to each other, the upper surface 22 of the first coupling plate 20 and the lower surface 32 of the second coupling plate 30 may be in contact with each other, and thus the two hand carts may not be moved up and down. In addition, the guide inclined surface 23 and the vertical contact surface 25 of the first coupling plate 20 may be in contact with the protruding couplers 33 and 35 of the second coupling plate 30, and thus the two hand carts may not be moved in right and left directions.

In order to prevent the two hand carts from being separated from each other, a coupling groove and a coupling pint that will be described below may be used. As such, the two coupled hand carts may not be moved forward and backward and thus may be fixedly coupled to each other.

The first coupling groove 50 shaped like “L” may be formed at one edge of the upper surface of the loading plate of the first cart (FIG. 4), and a second coupling groove 55 may be formed at a position corresponding to the first coupling groove at one edge of the upper surface of the loading plate of the second cart (FIG. 5). A coupling pin 60 (FIG. 6) may be coupled to the first coupling groove and the second coupling groove to couple the two adjacent hand carts to each other.

The first coupling groove 50 may include the horizontal groove 51 formed in parallel to the side surface of the hand cart, and the vertical groove 53 that extends in a vertical direction from one end of the horizontal groove 51 and the vertical groove 53 that extends perpendicular to the side surface of the hand cart. The vertical groove 53 may extends to the end of the loading plate. In addition, a first hole 54 and a second hole 52 that are vertically formed in the upper surface of the hand cart may be penetrated up and down in opposite sides of the horizontal groove 51.

The coupling pin 60 may be a coupling member shaped like “C” and may include a horizontal part 62 having a predetermined width, and a first vertical part 64 and a second vertical part 66 that extend downward from both ends of the horizontal part, and in this case the first vertical part 64 may extend with a relatively long length and the second vertical part 66 may extend with a relatively short length.

When the hand cart is used along rather than being coupled to another hand cart, a first vertical part 64 of the coupling pin may be installed in the first hole 54, and the second vertical part 66 may be installed in the second hole 52. In this case, the horizontal part 62 of the coupling pin 60 may be positioned in the horizontal groove 51 of the first coupling groove 50. A transverse through hole (not shown) may be formed in the first vertical part 64 of the coupling pin, and an anti-separation pin 68 may be coupled through the through hole. The first vertical part 64 may be installed in the first hole 54 and may then to couple the anti-separation pin 68, and thus the coupling pin may be prevented from being separated out of the loading plate. However, although the coupling pin is not separated out of the loading plate, the coupling pin may be capable of being moved up and down by a predetermined distance, and thus the current state may be the state in which the coupling pin is raised upward and rotated by 90 degrees for coupling side surfaces of hand carts, which will be described below.

However, when the first cart and the second cart are coupled to each other, the coupling pin 60 may be raised upward and rotated by 90 degrees, the second vertical part 66 of the coupling pin may be inserted into a third hole 56 formed in the second coupling groove 55 of the second cart, and then the first vertical part 64 of the coupling pin may be installed unchanged in the first hole 54 of the first cart. Thus, the first cart and the second cart may be simply coupled to each other through the coupling pin. To this end, the third hole 56 may be formed perpendicular to the upper surface of the hand cart in the second coupling groove 55. The second coupling groove 55 of the second cart may correspond to the vertical groove 53 of the first cart (refer to FIG. 7).

A protection plate 70 that is formed perpendicular to the lower surface of the hand cart while surrounding an external side of the first hole 54 may be provided on the lower surface of the loading plate of the hand cart according to the present invention. Since the first vertical part 64 of the coupling pin has a relatively long length, the first vertical part 64 may penetrate the loading plate and protrude below the lower surface in the state of being installed in the first hole 54. In this case, since the first vertical part of the coupling pin collides with the foot of a user who is doing a work, in order to prevent this, the protection plate 70 may be provided outside the first vertical part to protect the user from the first vertical part of the coupling pin.

The hand cart may be pushed or dragged using the handle, but in some cases, a string (wire) may be tied to a loading plate to drag the hand art, and in order to store the used string after use, a member for storing the wound string on the lower surface of the loading plate may be provided according to the present invention. That is, a string storage member 80 (FIG. 8) for storing the wound string may be further provided on the lower surface of the hand cart.

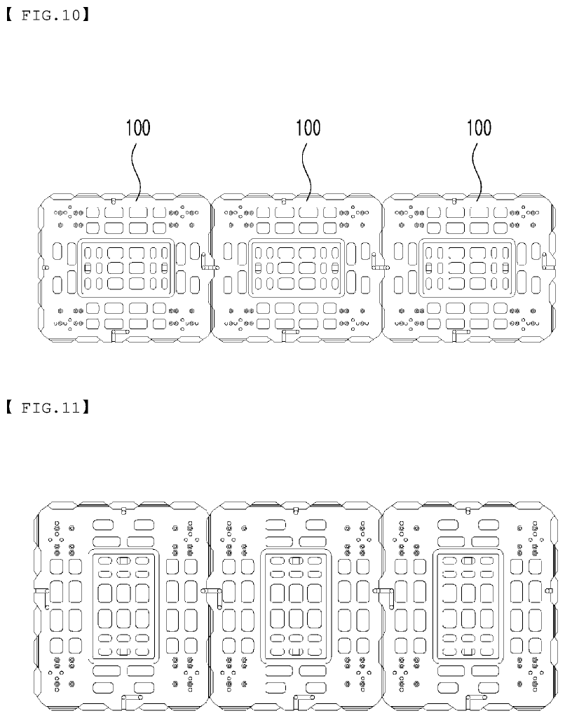

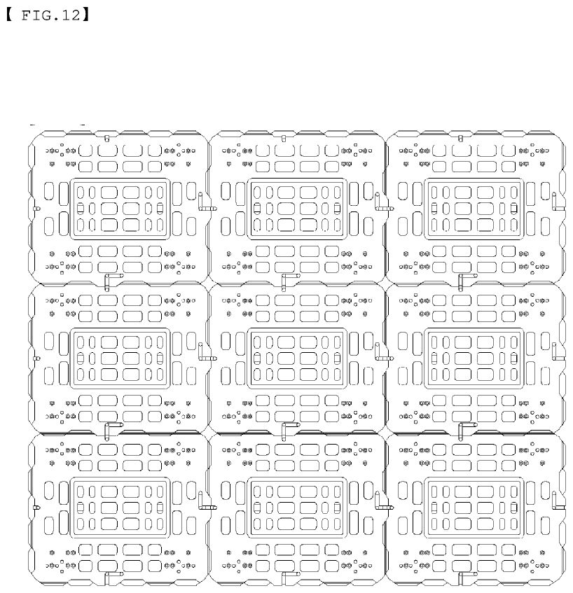

The hand cart according to the present invention may provide devices for coupling adjacent loading plates at four side surfaces, and thus the loading plates may be coupled in various forms to ensure a required loading area. That is, four loading plates may be coupled as shown in FIG. 9, loading plates may be coupled longitudinally in a row as shown in FIG. 10, loading plates may be coupled horizontally in a row as shown in FIG. 11, or a large number of loading plates may be coupled vertically and horizontally as shown in FIG. 12.

Although exemplary embodiments the present invention have been described in detail above, the scope of the present invention is not limited thereto, and various modifications and improvements by those skilled in the art using the basic concept of the present invention as defined in the following claims are also provided.

1. A hand cart comprising:
a loading plate (10) on which goods are loaded;
a first coupling plate (20) and a second coupling plate (30) that are alternately formed on a side surface of the loading plate;
a first coupling groove (50) shaped like “L” and formed at one edge of an upper surface of the loading plate;
a second coupling groove (55) formed at a remaining edge of the upper surface of the loading plate; and
a coupling pin (60) shaped like “C” and installed in the first coupling groove,
wherein a height of an upper surface (22) of the first coupling plate (20) is equal to or lower than a height of a lower surface (32) of the second coupling plate (30).

2. The hand cart according to claim 1, wherein, when side surfaces of the two hand carts are coupled to each other, a guide inclined surface (23) inclined toward a center of the loading plate is formed as a vertical surface on opposite sides of the first coupling plate (20) of any one of the hand carts, an inclined part (33) guided by the guide inclined surface (23) is formed at opposite sides of the second coupling plate (30) of a remaining one of the hand carts, and the upper surface (22) of the first coupling plate (20) overlaps the lower surface (32) of the second coupling plate (30).

3. The hand cart according to claim 1, wherein the coupling pin (60) includes a horizontal part (62) having a predetermined width and a first vertical part (64) and a second vertical part (66) that extend downward from both ends of the horizontal part, the first vertical part (64) extending with a relatively long length, and the second vertical part (66) extending with a relatively short length.

4. The hand cart according to claim 3, wherein the first coupling groove (50) includes:
a horizontal groove (51) formed in parallel to the side surface of the hand cart;
a vertical groove (53) extending from one end of the horizontal groove (51) to be perpendicular to the side surface of the hand cart; and
a first hole (54) and a second hole (52) that are formed in both ends of the horizontal groove (51) to be perpendicular to the upper surface of the hand cart,
wherein a first vertical part (64) of the coupling pin is installed in the first hole (54), and the second vertical part (66) is installed in the second hole (52).

5. The hand cart according to claim 4, wherein, when side surfaces of the two hand carts are coupled to each other, the second coupling groove (55) corresponding to the vertical groove (53) of the one hand cart is formed in the side surface of the remaining one of the hand carts, a third hole (56) is formed in the second coupling groove (55) to be perpendicular to the upper surface of the hand cart, and the second vertical part (66) of the coupling pin (60) is installed in the third hole (56) to couple the two hand carts.

6. The hand cart according to claim 4, wherein a protection plate (70) formed perpendicular to the lower surface of the hand cart while surrounding an external side of the first hole (54) is provided on the lower surface of the hand cart; and
wherein, in a state in which the first vertical part (64) of the coupling pin is installed in the first hole (54), the protection plate (70) protects a user from the first vertical part of the coupling pin.

7. The hand cart according to claim 1, further comprising:
a string storage member (80) provided on the lower surface of the hand cart and protruding vertically at a predetermined interval from the lower surface to store a wound string.
